(19) United States
(12) Patent Application Publication
(10) Pub. No.: US 2004/0215776 A1
(43) Pub. Date: Oct. 28, 2004

(54) Apparatus and method for distributing and displaying information over a computer network

(76) Inventor: Che Fai David Tam, Chatswood (AU)

Correspondence Address: STITES & HARBISON PLLC, 1199 NORTH FAIRFAX STREET, SUITE 900, ALEXANDRIA, VA, 22314, US

(21) Appl. No.: 10/169,334

(22) PCT Filed: Apr. 4, 2001
(86) PCT No.: PCT/AU01/00375

(30) Foreign Application Priority Data
Apr. 4, 2000 (AU) PQ6683

(51) Int. Cl. G06F 15/173

(52) U.S. Cl. 709/226

(57) ABSTRACT

The present invention provides a method of distributing information over a computer network and displaying or playing the information, involving: transmitting the information from a server to a computer of a user via the network while the user is accessing the network; and subsequently displaying or playing the information at one or more predetermined times. The present invention provides a method of controlling the distribution of information over a computer network, involving: transmitting the information from a server to a computer of a user via the network; and creating a user profile containing usage information pertaining to that user concerning the information transmitted to the user, and personal information pertaining to the user; and storing identification information identifying the user with the profile on the user computer but not on the server.

The present invention relates to a system and method for distributing and displaying information over a computer network, of particular but by no means exclusive application in transmitting and displaying information over the internet or world wide web, especially where that information is advertising material.

There exist various systems for transmitting and displaying information. WO 97/15020 discloses a method of browsing the world wide web, in which information objects are locally stored, retrieved and outputted to reduce the waiting time normally associated with the download of hypertext documents having high resolution graphics. Thus, while the client waits for a reply and/or as the hypertext document is being downloaded, the browser displays a previously-cached information object.

GB 2336082 describes a multi-levelled image display scheme for a computer, in which an interactive icon is displayed permanently on the screen and placed at all times on top of any other icons or open windows displayed simultaneously on the screen. The icon is replaced after a predetermined period of time.

WO 98/47090 teaches a method of providing on-line advertising during, for example, a world wide web session. Full page advertisements are downloaded from a predetermined site during a communication link idle time, stored, and then displayed when the user makes a request to retrieve new data.

WO 98/29810 discloses a network communications marketing system which also receives advertisements whenever the connection or communication path between a client station and a network service provider is idle. The network service provide monitors traffic to and from the client's station to determine when the connection path is idle, and advertising messages are transmitted, with other information, to the client station when the connection path is idle. Advertisements may be displayed in a predetermined location of a browser client window of the client station, and can be played/displayed for a predetermined time period.

These systems, however, do not enable the downloading of information even if the system is never, in fact, idle before the information is displayed, together with the ability to display the information at predetermined times.

The present invention provides, therefore, a method of distributing information over a computer network and displaying or playing the information, involving:

transmitting said information in any otherwise unused bandwidth from a server to a user computer via said network while said user is accessing said network, including transmitting at least a portion of said information while said user is actively accessing said network; and subsequently displaying or playing said information at one or more predetermined times.

Preferably the network is the internet and more preferably the world wide web.

Thus, the information is transmitted to the user's computer while the user is actively accessing the network, such as using a web browser, but at a low transmission rate so that the user access speed is not unduly reduced. This access may be punctuated by periods of idle time, during which the transmission of the information may continue, but the transmission is not restricted to the idle periods. It should be noted that the term information is used in its broadest sense, and includes text, video, images, audio, and any combination of these.

Preferably the method includes opening one or more new windows on the screen of said user computer, and displaying or playing said information in said one or more windows.

Preferably said one or more windows are neither closable nor concealable by said user while said user computer remains in operation.

In one embodiment, one or more of said one or more windows may include a plurality of portions in which may displayed or played different types of information contained within a piece of information.

Preferably said method includes:

creating a profile of said user on said user computer;

transmitting at least a portion of said profile to said server;

comparing said portion of said profile with characterizing data for each piece of information stored on or accessible by said server, in order to establish matches between said portion of said profile and said characterizing data; and

transmitting to said user computer only those pieces of information for which a match has been established between said portion of said profile and the characterizing data pertaining to that piece of information.

Thus, a portion of the user's profile (including up to 100% of that profile) can be transmitted to the server so that only information of interest or relevance to the user is transmitted to the user computer.

Preferably said method includes encrypting said portion of said profile before its transmission to said server.

Alternatively, said method includes:

creating a profile of said user on said user computer;

transmitting said information to said user computer together with characterizing data for each piece of information;

comparing said characterizing data for each piece of information and said portion of said user profile, in order to establish matches between said portion of said profile and said characterizing data; and

displaying or playing on said user computer only those pieces of information for which a match has been established between said portion of said profile and the characterizing data pertaining to that piece of information.

Preferably said method includes scheduling the displaying or playing of said information according to said portion of said profile.

Thus, the displaying or playing of the information can be scheduled according to the data pertaining to an individual user.

Preferably said method includes transmitting said information in encrypted form to said user computer.

Preferably said method includes logging the transmission to and/or displaying or playing of said information by said user, on said user computer and/or said server.

In one preferred embodiment, the user computer is one of a plurality of comparable user computers, each able to receive information via said network from said server. In this embodiment, each user's profile will be created on his or her own computer, and each user will be treated independently of any other user.

Alternatively, a single user computer may in fact be used by multiple users, each with his or her own account or access rights. In that case, the method preferably includes regarding each user, though sharing a single computer, as separate from all other users. For example, each user will have a separate profile, and—for each user—the selection of information for transmission or display will be independent of any other user. However, the information displayed or played to each user may be drawn from the same information database transmitted from the server and stored on the user computer, to minimize the required storage space.

The present invention also provides an apparatus (such as one or more computers and/or a computer readable medium) for distributing information over a computer network and displaying or playing the information, having computer program portions loadable onto and executable by said server and said user computer for performing the method described above.

In one embodiment the method also involves:

creating a user profile containing usage information pertaining to that user concerning the information transmitted to said user, and personal information pertaining to said user; and

storing identification information identifying said user with said profile on said user computer but not on said server.

Preferably said identification information is a part of said profile.

Preferably said profile is stored on said server unless said profile includes said identification information in which case said profile except for said identification information is stored on said server.

Thus, the profile can be used for establishing suitable information or content to be transmitted to the user, but the central server cannot identify the user other than demographically. Information (or a precis thereof) can either be transmitted to the user computer and compared with the personal information, and only relevant information fully downloaded and displayed, or the profile without the identification information transmitted to the server where this comparison can be performed.

In order that the invention may be more fully ascertained, a preferred embodiment will now be described, by way of example, with reference to the accompanying drawing, in which:

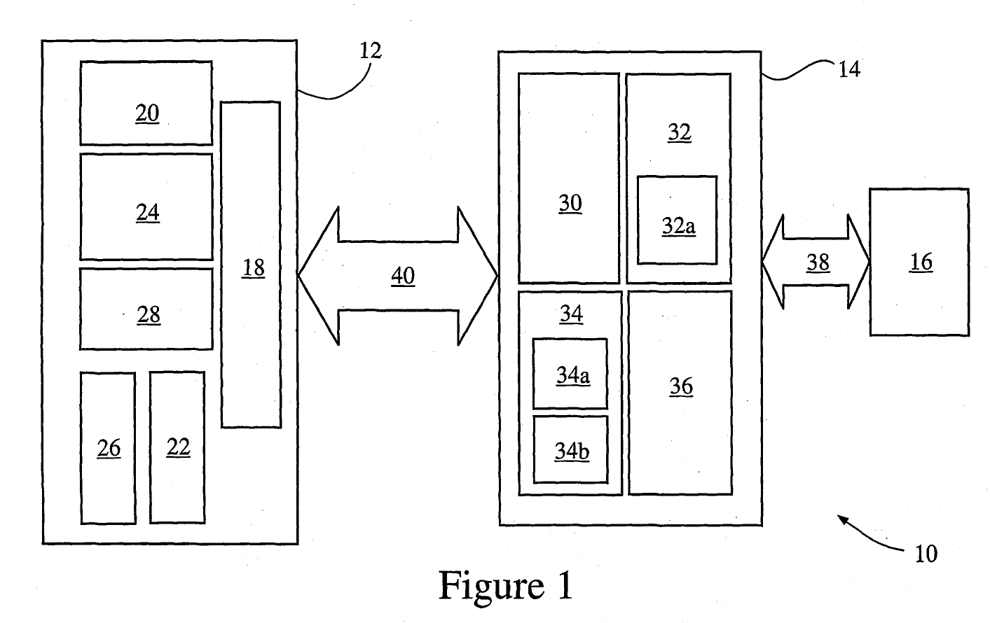

FIG. 1 is a schematic representation of the architecture of a system for providing information over the internet according to a preferred embodiment of the present invention;

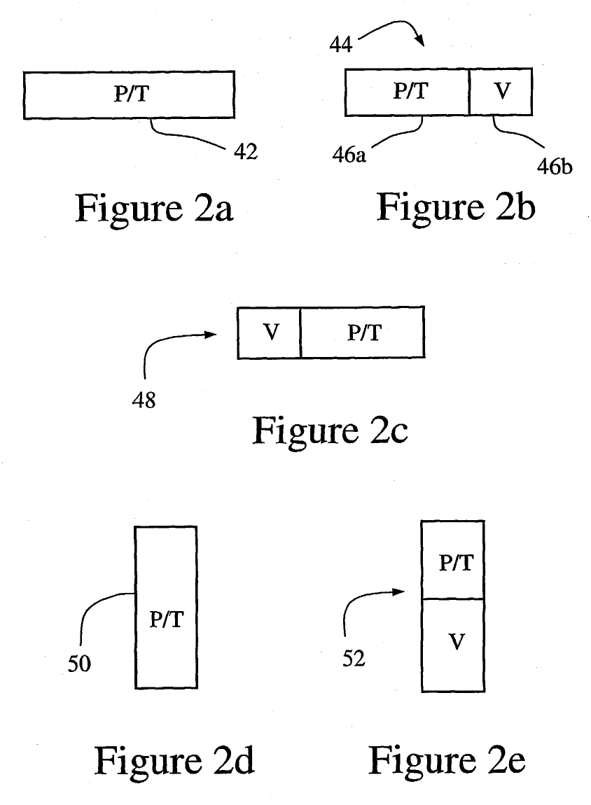

FIG. 2 is a schematic representation of a sample configurations of an MWP window of the system of FIG. 1; and

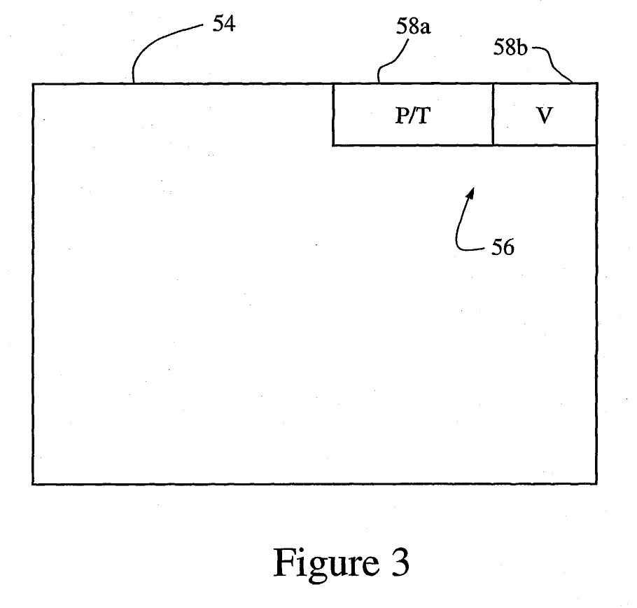

FIG. 3 is a schematic representation of a sample display of an MWP window sitting on top of a user computer screen in the system of FIG. 1.

A system for distributing information over the internet and displaying that information, according to a preferred embodiment of the present invention, is represented schematically at 10 in FIG. 1.

The system 10 includes a user computer 12 and a server 14, the latter connected to the internet 16. For simplicity, only a single user computer 12 is depicted in this figure, but it should be understood that there will generally be many user computers 12 for any one server 14.

The user computer 12 is provided with software and memory storage registers including a local agent 18 that controls local operation of the system 10, a player 20 for playing downloaded material in a window displayable on the screen of the computer 12, local content store 22 for storing downloaded material, a local content scheduler 24 for controlling the timing of the local playing of downloaded material, a user profile 26 comprising user profile information and an local interaction logger 28 for locally logging usage of the system.

The server 14 includes a main database 30, server scheduler 32 (including server scheduler database 32a), server interaction logger 34 (including logger manager 34a and logger database 34b), and main server program 36.

The server 14 is connected 38 to the internet; the system 10 also includes a link 40 between the server 14 and the user computer 12 for encrypted system traffic (discussed below), as well as other traffic requiring less security. Link 40 is—in this embodiment—an internet link, but can be any other suitable link including a dial-up modem link or a broadband link.

The player 20 generates a window for displaying on the screen of the user computer 12 any downloaded material (stored in local store 22) that the system 10 has served to the user while the user is online. The content that is displayable the following information types or combinations thereof:

Text

Graphics (static or animated)

Video

Sound

The look and feel of the window can be set by the system 10 as desired by the provider of the information and to maximise communication effectiveness.

FIGS. 2a to 2e depict schematically a number of possible window configurations, by way of example. In these figures, “P” designates a still or animated picture, “T” designates text, and “V” designates video. Thus, FIG. 2a depicts a window 42 (which may occupy any desired proportion of the screen area, but typically about an eighth) in which either picture only or text only is displayed, while FIG. 2b depicts a window 44 that in fact is split into two portions, the first or left portion 46a displaying only a picture or text, the second or right portion 46b displaying video. FIGS. 2c, 2d and 2e display similar windows 48, 50 and 52 respectively, each for displaying the specified material.

It will be seen that, according to the system 10, both window shape and content can assume many possible configurations.

The window produced by the system 10 on the screen of the user computer 12 is “always on top”, in that, it cannot be covered by another window or minimized, thereby covering or concealing the displayed information.

FIG. 3 is a schematic representation of the screen 54 of the user's computer 12, in which a web browser (not shown) is being used to display information from the Internet, and on which is additionally displayed a window 56 generated by the system 10. The window 56 is divided into left and right portions 58a and 58b respectively, the left portion 58a displaying a picture or text only, the right portion 58b displaying video information.

The attributes of the window may be specified by the server for each information content served on the user's computer 12, these attributes including:

Startup position;

Play duration;

Size (x, y dimensions);

Sound volume control bar availability;

Availability of grab handle bar (for each moving of the window);

Size of graphical picture;

Position of graphical picture within the window;

The type of graphical picture to be played (for example, GIF, JPG, PNG or MNG);

Size of video window;

Position of video window;

Special effects;

Size and position of each interactive hot-spots in the window;

URL links to each of the hot spots, graphical area or video window;

Initial Sound volume of video picture; and

The used-by date of a MWC, so that outdated MWC will be discarded from the user computer once it expires.

As discussed above, the displayed window cannot be disabled or minimised whilst the user is connected, but it can be moved around the user's screen by the user. The system 10 employs a “heart beat” signal that maintains a regular contact with the central server 14 so that, if the window is somehow killed by the user or a hacker, the central server 14 will know that this has occurred within a short time, and take appropriate action (such as disconnecting the user or repairing the window). The heart-beat communication channel is encrypted so as to protect it from being mimicked by the user or a hacker.

The system 10 includes a user operable function to save information displayed in a window for later replay, but the user cannot stop the displaying of the material at the times specified by the server 14.

A user can interact with the information displayed in the window by clicking any one of a number of hot-spot or hypertext areas within the window. Upon selection of such a hot-spot, a link to a web site will be activated and active web browser being used by the user will be directed to connect to that site. If a browser is not active, the default browser will be started and this will connect to the specified web site.

In order to protect the integrity of the content from tampering, all content is encrypted with a signature. The player 20 checks the signature of all content before displaying the material.

The content is served on the user's computer 12 by two programs. The first is the main server program 36, which runs on the server 14 and acts as a slave to the agent. Its function is to listen to the agent 18 and forward information to the user's computer 12 as required. The second program is the agent 18 itself, which runs on the user computer 12, co-ordinates all communication activities with the server 14 and controls other functions on the user's computer 12.

The main server program 36 may be in simultaneous communication with a plurality (indeed, possibly thousands) of agents 18, and distributes its decision making to the agents 18 running on the user's computers 12.

The agent 18 is initially either downloaded from a nominated web site or via a setup computer readable storage medium provided to the user, such as a compact disc. Once downloaded, the agent 18 can update itself and various other components of system 10 operating on the user computer 12. Unless the update involves fundamental changes, it is not necessary to re-boot the user computer, thus making the update unnoticeable to the user.

The agent 18 establishes a connection between the user computer 12 and the server 14, authenticates the user, controls the users activity path (e.g. which web sites the user is permitted to access), monitors for any hacker activity and monitors traffic on the link 40 to allow a smooth downloading of content from the server 14 alongside other Internet data.

The data served from the server 14 can be of various types, including:

configuration data for player 20;

configuration data for agent 18 (e.g. network communications parameters);

configuration of data for the local content store 22;

information files, e.g. picture files, video and/or sound files to be displayed by the agent 18;

Schedule/profiling requirements for the local scheduler 24;

List of active content;

Encryption algorithm for transmission of encrypted data via link 40;

New versions of or patches for the player 20 or agent 18; and

Housing keeping action list—e.g. erase outdated content.

Data is served on the user computer 12 by server 14 in parallel with other user Internet data traffic, which may include HTML Web pages, data transmitted by FTP, email, Telnet or other legitimate Internet communications. The system 10 detects the presence of the user's own Internet traffic and defer right-of-way to that traffic according to preset parameters. For example, the agent 18 can be allocated a minimum amount of bandwidth for its own use instead of deferring totally to other Internet traffic. The system 10 detects the speed gradient of the online traffic, and matches its own traffic speed to take up the maximum bandwidth available between the user computer 12 and the server.

The agent 18 controls the serving of all information on the user's computer 12; it decides whether a certain piece of content will be displayed, what—if any—additional files will be required to do so, and when those files should be downloaded. By doing this, the decision load is distributed to the user computer 12, enabling the server 14 to be scalable for a large number of user computers 12.

The system 10 also allows unplanned interruption of the user's communication link 40 with the server 14, by storing where in a download an interruption occurred, and restarting the download from that point when the communications link 40 is re-established.

The information served this way may be displayed in with relatively small delay in a system window (such as window 56 discussed above) or stored on the user computer 12 for later display and replay.

All information downloaded by the system 10 to the user's computer 12 is encoded/encrypted to prevent illegal interception and/or insertion. The encryption protects the integrity of the information being displayed. In order to provide a strong degree of protection from continuous hacking efforts, the encryption mechanism is changed regularly.

The system 10 includes an intelligent information scheduler comprising local scheduler 24 and server scheduler 32, which determines what content server 14 is to serve on a user's computer 12 when that user is online, according to criteria such as:

User's gender, age group, location;

User's usage pattern on the Internet;

Date and time schedules; and

Replay of information according to pre-programmed requirements.

As described above, the scheduler is divided into two parts, one part (local scheduler 24) residing on the user computer 12, the other (server scheduler 32) on the server 14. The server scheduler 32 merely maintains database 30 of the currently available content to be served to the user. Each piece of this content is coded with the user profile of the target user on whom it is to be served. This information, together with any physical time scheduling requirements, constitutes the server scheduling information stored in server scheduler database 32a.

Each piece of server scheduling information is provided to and inspected by local scheduler 24, which identifies matches between server scheduling information and user profile 26, thereby deciding which content should be displayed and when it should be displayed. The benefits of doing this are:

reduction in the computing power required by the server 14, by distributing the profiling matching load from the server 14 to the user computer 12,

simplification of the server software 36, thereby resulting in greater reliability; and

maintenance of maximum user privacy by storing key user profile information on user computer 12, rather than on server 14.

Whenever a user is connected online via the agent 18, all the user's interaction activities with the Internet as well as the information served through player 20 are transmitted to the server 14, and logged by server interaction logger manager 34a. This information is warehoused in database 34b without direct user identification, which is stored only on the user's computer 12.

Activities logged for each piece of content played by the player 20 are analysed according to the demographic details of the user, and the system 10 then produces demographic reports of the usage of the system 10, providing a useful source of market research data.

The system 10 thus enables the serving and displaying of video, graphical and textual information through an “always on top” window on a computer 12. It allows the serving of this information during the time a user is connected to the Internet via a communication link connecting the user computer to the server of information.

The system 10 can be applied to any link 40 between the user computer 12 installed with the agent 18 and the server 14, such as dial-up modem connections, broadband connections as well as over the Internet. The system 10 allows the serving of information to the user concurrently with the user's normal Internet data traffic with minimum interruption to the Internet traffic. Information is programmed to re-appear in the window over a prescribed period of time and is stored in the user computer 12 for replay.

Modifications within the spirit and scope of the invention may readily be effected by a persons skilled in the art, so it is to be understood that this invention is not limited to the particular embodiments described by way of example hereinabove.

1. A method of distributing information over a computer network and displaying or playing the information, involving:
transmitting said information in any otherwise unused bandwidth from a server to a user computer via said network while said user is accessing said network, including transmitting at least a portion of said information while said user is actively accessing said network; and
subsequently displaying or playing said information at one or more predetermined times.

2. A method as claimed in claim 1, wherein said network is the internet or the world wide web.

3. A method as claimed in claim 1, wherein said information is transmitted to said user computer while said user is actively accessing said network at a low transmission rate so that user access speed is not unduly reduced.

4. A method as claimed in claim 1, including continuing transmitting said information during periods of idle time within said accessing of said network.

5. A method as claimed in claim 1, including opening one or more new windows on a screen of said user computer, and displaying or playing said information in said one or more windows.

6. A method as claimed in claim 5, wherein said one or more windows are neither closable nor concealable by said user while said user computer remains in operation.

7. A method as claimed in claim 5, wherein one or more of said one or more windows includes a plurality of portions for displaying or playing different types of information contained within a piece of information.

8. A method as claimed in claim 1, including:
creating a profile of said user on said user computer;
transmitting at least a portion of said profile to said server;
comparing said portion of said profile with characterizing data for each piece of information stored on or accessible by said server, in order to establish matches between said portion of said profile and said characterizing data; and
transmitting to said user computer only those pieces of information for which a match has been established between said portion of said profile and the characterizing data pertaining to that piece of information.

9. A method as claimed in claim 8, including encrypting said portion of said profile before its transmission to said server.

10. A method as claimed in claim 1, including:
creating a profile of said user on said user computer;
transmitting said information to said user computer together with characterizing data for each piece of information;
comparing said characterizing data for each piece of information and said portion of said user profile, in order to establish matches between said portion of said profile and said characterizing data; and
displaying or playing on said user computer only those pieces of information for which a match has been established between said portion of said profile and the characterizing data pertaining to that piece of information.

11. A method as claimed in claim 8, including scheduling the displaying or playing of said information according to said portion of said profile.

12. A method as claimed in claim 1, including transmitting said information in encrypted form to said user computer.

13. A method as claimed in claim 1, including logging the transmission to said user of said information, or the displaying or playing of said information by said user, or both the transmission to said user of said information and the displaying or playing of said information by said user.

14. A method as claimed in claim 13, wherein said logging is onto said user computer or onto said server or onto both said user computer and said server.

15. A method as claimed in claim 1, wherein said user computer is one of a plurality of comparable user computers of respective users, each able to receive information via said network from said server.

16. A method as claimed in claim 15, including creating a user profile for each of said respective users on the respective user computer of each of said users, whereby each of said users can be treated independently of any other of said users.

17. A method as claimed in claim 15, wherein said user computer is operable by multiple users, each of said users having a respective account on or access rights to said user computer.

18. A method as claimed in claim 17, including treating each of said users, though sharing said user computer, as separate from all others of said users.

19. A method as claimed in claim 17, wherein each of said users has a separate profile, and for each user the selection of information for transmission or display is independent of any other of said users.

20. An apparatus for distributing information over a computer network and displaying or playing the information, having computer program portions loadable onto and executable by said server and said user computer for performing the method as claimed in claim 1.

21. A method as claimed in claim 1, involving:
creating a user profile containing usage information pertaining to that user concerning the information transmitted to said user, and personal information pertaining to said user; and
storing identification information identifying said user with said profile on said user computer but not on said server.

22. A method as claimed in claim 21, wherein said identification information is a part of said profile.

23. A method as claimed in claim 22, including storing said profile on said server if said profile does not include said identification information or, if said profile includes said identification information, storing said profile except for said identification information on said server.

24. An apparatus for controlling the distribution of information over a computer network, having computer program portions loadable onto and executable by said server and said user computer for performing the method as claimed in claim 21.
